(19) United States
(12) Patent Application Publication
(10) Pub. No.: US 2020/0019646 A1
(43) Pub. Date: Jan. 16, 2020

(54) CLOUD STORAGE AGGREGATOR SYSTEM AND METHOD

(71) Applicant: 9788204 Canada Inc., Kitchener (CA)

(72) Inventor: Mahmoud Reza Tadayon, Kitchener (CA)

(21) Appl. No.: 16/033,362

(22) Filed: Jul. 12, 2018

(51) Int. Cl. G06F 17/30; G06Q 30/06; G06F 21/62; H04L 29/06

(52) U.S. Cl. CPC G06F 17/30905; G06Q 30/0645; H04L 63/102; G06F 17/30203; G06F 21/6218; G06F 17/30165

(57) ABSTRACT

A cloud aggregator system for aggregating a number of cloud-based services and permitting a user to access and share files and storage space is provided. The system includes an internal database hosted on a computer server. The server is configured to access the internal database. An application configured to access the server, the application including an interface for the exchange of information between a user device and the server. The server provides a plurality of computing services to the user. The server is configured to access and manipulate files and storage located, share files between users, share space between the users of the cloud aggregator system, and allow a user to rent space to another user of the cloud aggregator system and/or to the external user.

### TECHNICAL FIELD

The embodiments disclosed herein relates to file and cloud storage access and sharing, and, in particular to systems, devices, and methods for providing file and storage access and sharing in a cloud-hosted environment.

### BACKGROUND

Cloud storage services may allow users to store data, access the data from various location, and share the data with other people. Cloud service providers such as Dropbox™, Google™ Drive™, or Microsoft™ OneDrive™ store personal documents, photos, and videos, etc., and allow for sharing these documents with friends and family. Companies may have limited physical storage resources. Cloud accounts may be adopted for professional purposes, for example to store work-related files, collaborate with co-workers, or back up data.

There is a proliferation of cloud storage accounts and lack of interoperability between different cloud services. Managing and sharing cloud-hosted files may be difficult. Managing and sharing files that are hosted on multiple cloud service providers may be difficult. To save costs, a user may only use the amount of free space provided by default by the cloud service provider. This space may be relatively small (for example, tens of gigabytes). In order to accommodate growing storage demands, users may sign up for multiple accounts on different cloud service providers and/or within the same service under different usernames. Users may subscribe to multiple cloud service providers to take advantage of free storage space. The cloud service providers each have their own website requiring specific authentication and security protocols for file access, storage and sharing. Users' files may be scattered across multiple cloud accounts, making file maintenance and navigation cumbersome and unmanageable.

There may be a lack of interoperability between cloud service providers and sharing files between different cloud service providers may not be permitted or such functionality may not be available. For example, a Dropbox™ user may not be allowed to share a file and edit the file jointly with a Google™ Drive™ user. This may limit collaboration between co-workers, friends, or family members that are using different cloud service providers. Consequently, users may create cloud accounts on the same cloud service provider so that they can access common files using the internal file sharing mechanisms of that same cloud service provider. In addition, users may subscribe to a plurality of cloud service providers to share files with other users who have a subscription with a particular cloud storage provider. Given the amount of users who store numerous documents on multiple cloud service providers, document access and transmission can be cumbersome, as a user has to individually deal with each cloud storage provider separately.

To address these issues, a cloud aggregator system can provide users a global view of all their files and cloud storage resources scattered among multiple cloud service providers and enable file and cloud storage access and sharing with others.

### SUMMARY

According a broad aspect, a cloud aggregator system for aggregating a number of cloud-based services and permitting a user to access and share files and storage space is provided herein. The system includes: an internal database hosted on a computer server, the internal database comprising machine-readable computer storage media configured to store computer files and provide access to storage space, both the computer files and the storage space being associated with an account of a user, a server configured to access the internal database, an application configured to access the server, the application comprising an interface for the exchange of information between a user device and the server, wherein the server provides a plurality of computing services to the user, and wherein the server is configured to: access and manipulate files and storage located on a user account of an external cloud service provider, share files between users of the cloud aggregator system, share space between the users of the cloud aggregator system, and allow a user to rent space to another user of the cloud aggregator system.

In some embodiments, the interface is a web-based interface.

In some embodiments, the external user does not have an account with the cloud aggregator system.

In some embodiments, the server allows the user with an account on the cloud aggregator system to store files on the internal database.

In some embodiments, the server allows the user to define access privileges over the shared space.

In some embodiments, the server allows the user to define access privileges over the rented space.

In some embodiments, the access privileges includes at least one of read, write, share, manage and delete privileges over the rented space.

In some embodiments, the server allows the user to define at least one condition for the rented space.

In some embodiments, the at least one condition includes: a renting space term; a required geographic location; a response time; a billing/pricing condition; an allocation of a specific amount of storage; an allocation on demand condition; and an encryption requirement.

According a broad aspect, a method of sharing a file and/or space on a cloud aggregator system aggregating a number of external cloud service providers is provided herein. The method includes authenticating a user of the cloud aggregator system, determining an amount of available space on the cloud aggregator system and/or on at least one of the external cloud service providers, determining whether a desired share is local and/or external, wherein a local share is a share of a file that is to be saved on an internal database of the cloud aggregator system, and wherein an external share is a share of a file that is to be saved on a database of the external cloud service providers, and sharing the file locally and/or externally.

In some embodiments, the method includes allowing a recipient of the file share and/or cloud storage share to manage privileges access to the file share and/or cloud storage share.

According a broad aspect, a method of renting a space on a cloud aggregator system aggregating a number of external cloud service providers is provided herein. The method includes authenticating a user of the cloud aggregator system, determining an amount of available space on the cloud aggregator system, determining whether a desired rent is local, wherein a local rent is a rent of a space located on an internal database of the cloud aggregator system, and renting the space locally.

In some embodiments, the method includes defining access privileges associated with the rented space.

In some embodiments, the access privileges include at least one of read, write, share, manage and delete privileges.

In some embodiments, the method includes defining at least one condition for the rented space.

In some embodiments, the at least one condition includes: a renting space term; a required geographic location; a response time; a billing/pricing condition; an allocation of a specific amount of storage; an allocation on demand condition; and an encryption requirement.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 shows a diagram of a cloud aggregator system and network, in accordance with an embodiment.

FIG. 2 shows an interface of a cloud aggregator system, in accordance with an embodiment.

FIGS. 3A and 3B show detailed diagrams of the interface of the cloud aggregator system of FIG. 2.

FIG. 4 shows a method for using a cloud aggregator system, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present subject matter.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

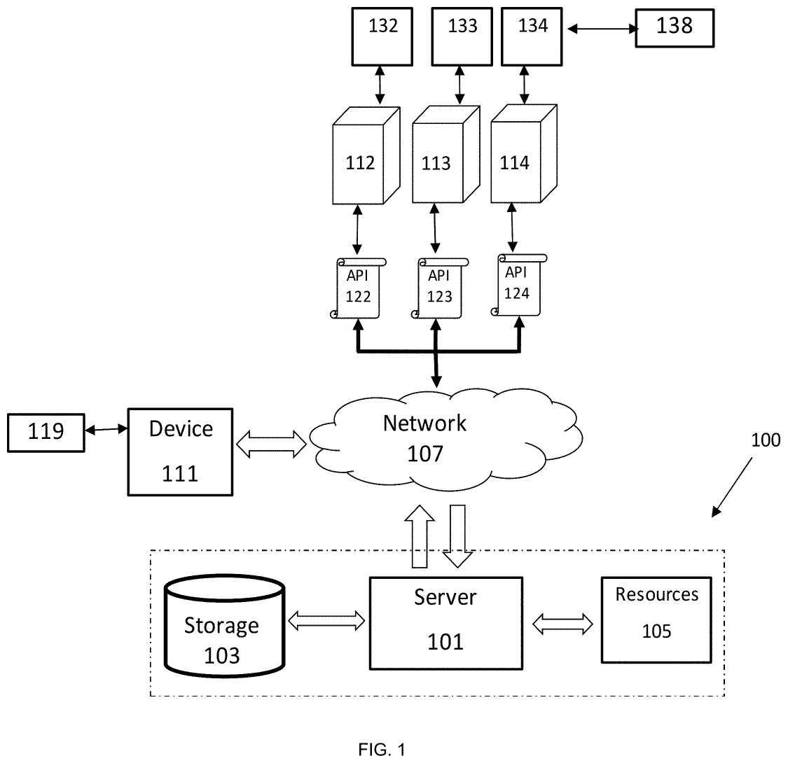

Referring to FIG. 1, there is provided a cloud aggregator system 100 for aggregating a plurality of cloud-based services. The cloud aggregator system includes a computer server 101, storage devices 103 and resources 105. The computer server 101 may include a file storage aggregation API and a backend processing system.

A bus/interface controller may be used to facilitate communications between the server and the storage devices via a storage interface bus. The storage devices 103 may be one or more removable storage devices, one or more non-removable storage devices, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example of computer storage media may include volatile and nonvolatile, removable and non-removable media implemented in any method or technology for storage of information, such as computer readable instructions, data structures, program modules, or other data.

The bus/interface controller may also be used to facilitate communications between the server and resources 105. The resources 105 include devices for configuring the computer server. The resource device 105 includes a network controller, which may be arranged to facilitate communications with one or more other computing devices over a network communication link via one or more communication ports. The one or more other computing devices may include servers, computing devices, and comparable devices.

The computer server 101 communicates with a network 107 via communication link. The network 107 may include servers, clients, Internet service providers, and communication media. Network 107 may include a secure network such as an enterprise network, an unsecure network such as a wireless open network, or the Internet. Network 107 coordinates communication over other networks such as PSTN or cellular networks. The network may include wireless media such as acoustic, RF, infrared and other wireless media.

Network 107 provides communication between the computer server 101 and devices 111. The devices 111 can have user displays 119. Devices 111 can be a device of a user of the cloud aggregator system 100. For example, a user's device can be a desktop, laptop, notebook, tablet, smart phone or the like.

Network 107 provides communication between the computer server 101 and cloud service providers 132, 133 and 134 through cloud service devices 112, 113 and 114. A user can have an account 138 on a cloud service provider 134 to access cloud services on the cloud service provider 134.

The computer server 101 communicates with the cloud service providers using application user interfaces (APIs). Each cloud server provider can have a different API for interfacing with the server. The computer server 101 and cloud service providers 112, 113 and 114 communicate using APIs 112, 123 and 124 respectively.

The cloud aggregator system can implement a multi-user multi-cloud file sharing layer. The system 100 exposes to the user a unified view of all files and cloud storage resources, located in its individual accounts on other cloud service providers. The system also provides the user additional cloud storage resources and tools. The system enables file sharing across a variety of accounts on cloud service providers. A user can register in the system pre-existing accounts located at external cloud service providers, such as Dropbox™, Google™ Drive™, or Microsoft™ OneDrive™.

The cloud aggregator system can maintain a local cache of user files persistently stored on cloud-backed accounts. The cloud accounts can be hosted by cloud service providers. These cloud accounts can be provided by the user. In one embodiment, files can be stored in the cloud aggregator system. In another embodiment, files are not stored on the cloud aggregator system, but instead on cloud accounts provided by users.

The system provides a unified view of the user's files stored in those cloud service providers. The user can share files with other users using the system. The user can also revoke access to these file in the future. The system can allow the user to set privileged access to files stored on the cloud service providers, and provide end-to-end data confidentiality.

The system provides the unified view of the storage resources the user has on those different cloud service providers. The storage resource can be the amount of storage (for example, available storage for storing files). The user can share storage with other users using the system. The user can also revoke access to the storage resources. The system can allow a user to set privileged access to a storage resource.

The cloud aggregator system can be configured to interface with a user's device, such as a desktop, laptop, notebook, tablet, smart phone or the like. In some cases, the system can include software installed onto the user's device (e.g., desktop or laptop), or it may comprise an application downloadable to the user's device (e.g., tablet or smart phone). By way of another example, embodiments of the cloud aggregator system can be entirely web-based application. For example, all embodiments of the cloud aggregator system are configured to interface with any and all such devices.

For example, a user's can include a graphic user interface to permit the user to control and manage accounts on the cloud aggregator system. For example, the user's device can include a web browser (such as Google™ Chrome™, FireFox™, etc.), a driver/application for cloud access, local storage (such as a hard drive or solid state memory) and optionally an external hard drive or solid state memory. For example, the user's device can also include an email client (such as Microsoft™ Outlook™), an email client plug-in, and social network applications (such as Instagram™, Facebook™, etc.), each of which permits a user to transmit digital data electronically through a network or Internet. For example, some of the above features may not be on every user device, as some as optional features not necessary for use of the device or for interface with embodiments of the cloud aggregator system.

The cloud aggregator system can aggregate a number of cloud-based services into an interface configured to permit a user to access and share files. The interface can also be configured to enable a user to share storage space. For example, the system can be configured to interface with a plurality of cloud storage providers. For example, the number of cloud storage providers can be as little as two or as many as the user desires to associate with the system.

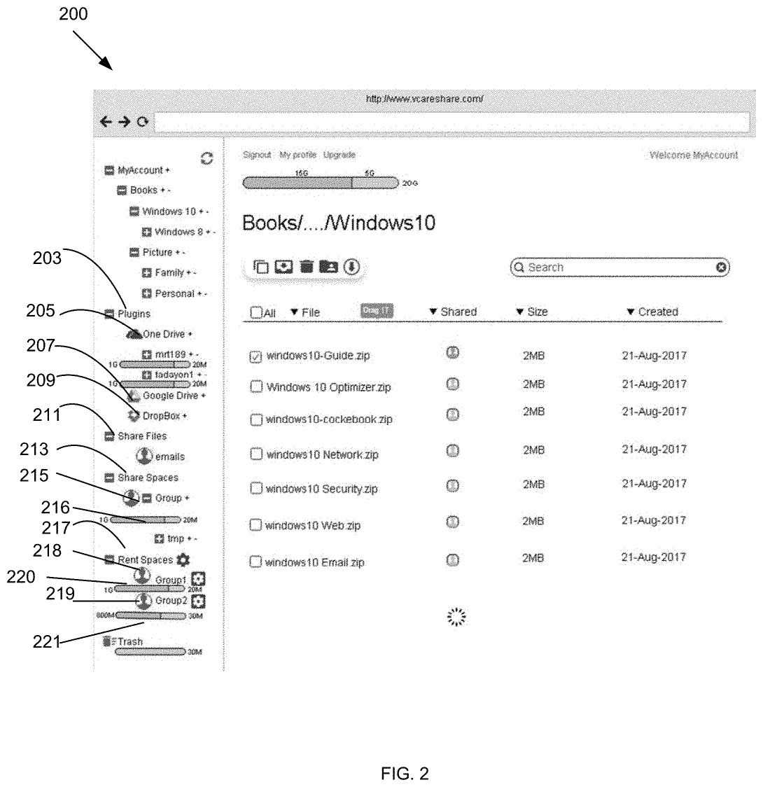

Referring to FIG. 2, there is disclosed an interface 200 of a cloud aggregator system. The cloud aggregator system can include a command line interface, which contains text only, and a graphical user interface, which also includes images (e.g., windows, icons and menus). For example, the cloud aggregator system can include the web-based interface 200.

The cloud aggregator system includes plugins, which are shown on the plugins tab 203. The plugins uses application-programming interfaces (APIs) to interact with other accounts on cloud service providers. By using APIs, the cloud aggregator system can be configured to communicate with a number of cloud service providers. The APIs allow the cloud aggregator system to communication with a cloud service provider, so that a user can send data to it, and access and work with data stored in it. For example, as shown at 205, the cloud aggregator system is configured to communicate with Microsoft™ OneDrive™; at 207, the cloud aggregator system is configured to communicate with Google™ Drive™; at 209, the cloud aggregator system is configured to communicate with Dropbox™. Each of the cloud service providers can have a distinctly different API.

The interface 200 includes a shared file tab 211. The shared files tab 211 shows the files that are shared between the account owner and other users of the cloud aggregator system. For example, these users are registered with the cloud aggregator system. The shared files tab 211 includes an email tab, which shows the emails of users that shared at least a file with the account owner. For example, the shared files tab shows the files that other users have shared with the account owner. The files can be saved on the internal databases of the cloud aggregator system.

The interface 200 includes a shared space tab 213. The shared space tab shows the storage space that are shared between the account owner and other users of the cloud aggregator system. At 215, it is shown that the account owner is part of a Group. A storage status bar 216 is also shown for the Group. The storage status bar shows the amount of available space compared to the total amount of space allocated to that particular group.

For example, a user can be allowed and/or restricted to write on a shared space. By ensuring that users can only store content in their own accounts, the system can also allow a user to share space with other users; therefore, users can “free ride” on the cloud storage space owned by other users. For example, cloud accounts can be managed independently per user. For example, users can control their files, even if they share it with others.

The cloud aggregator system includes rented spaces, as shown on the interface 200 at 217. The rented space tab shows the different rented space groups that a user is part of. In FIG. 2, the account owner is part of Group 1 (218) and Group 2 (219). Storage status bars 220 and 221 are shown for Group 1 and Group 2 respectively. The “rented space” feature allows the account owner to rent cloud storage space to another user of the cloud aggregator system. The “rented space” feature can allow the account owner to rent cloud storage space to an external user who is not registered into the cloud aggregator system. As such, a person does need an account with the cloud aggregator system to receive a rented space.

The rented space can be located on the internal database of the cloud aggregator system.

The cloud aggregator system can allow an account owner to define privileges over the rented space. For example, the privileges can include Read, Write, Share, Manage and Delete privileges over the rented space. For example, a Read privilege allows a user to view and open files that are located on the rented space. A user is not able to save files on the rented space with a Read privilege.

A Write privilege grants the user all the privileges of a Read privilege, but also allows the user to save files on the rented space. A Share privilege allows a user to share the rented space with other people. A Manage privilege allows a user to manage the rented space, such as assigning and updated privileges and sharing the rented the rented space. A Delete privilege allows a user to delete files located on the rented space.

For example, the rented space tab can show cloud storage space that the account owner has rented to other people, including users of the cloud aggregator system and external users. An external user is a user who is not registered and/or does not have an account with the cloud storage system. In one embodiment, the system can be configured to ask an external user to register with the system before renting space to that user. The rented space tab can also show files that the account owner has shared with users.

The cloud aggregator system can allow an account owner to define conditions associated with the rented space. For example, the conditions can include: a renting space term; a required geographic location; a response time; a billing/pricing condition; an allocation of a specific amount of storage; an allocation-on-demand condition; and an encryption requirement.

Using a renting space term, a space owner can specify a period of time for which the cloud storage space is available to other people. For example, the space owner can define a different renting space term for each user the space is rented to. With a required geographic location, the space owner can define a geographical location for each user of the rented space. For example, the space owner can specify that only people in Canada have access to the rented space.

With a response time condition, the space owner can specify how long the space will be available to a user before the user login into the space for the first time. For example, the owner of the space can specify that a particular user has 10 hours to access the space for the first time once a link has been sent to that user; and if the user does not access the space within that 10 hours, the user will not be able to access and use that rented space.

In one embodiment, using a billing/pricing condition, the space owner can ask the user for contribution/payment before or while having access to the rented space. For example, a link to a payment system can be created and sent to the user, such that the user makes a payment before and/or while using the rented space. With this option, a space owner can monetize her cloud storage space. This option also allow a space owner to monetize access to files that are saved on the rented space.

Using this condition, a space owner can allocated a specific amount of storage to each of the users of the rented space. Using an allocation-on-demand condition, a space owner can provide a user the option to ask for more rented space, for example, when there is no more free space for saving file. Using an encryption requirement, a space owner can specify that the rented space ask for an encryption key/code before giving access to a file saved on the rented space.

In case of file sharing, users can retain control of their files. In one embodiment, files can have a fixed location on the cloud aggregator system that belongs to the owner of the file. For example, the location of a given file can be named the file home. As writes are performed to the files, inconsistencies may arise between local copies and the primary replica in the file home. For example, to resolve inconsistencies, version numbers (VN) can be assigned to each file. The VN can be tracked by the server. For example, for each local file replica, the server keeps track of (a) a file's local version number, which can correspond to the downloaded version, and (b) a flag, which is set to 1 if the user modifies the file. For example, local file modifications can be put in a queue to be propagated by the cloud server. Periodically, the server synchronize the local cache with the files' homes. For example, in case of a write conflict, the local file copy is put in quarantine in a special directory to be manually resolved by the user. For example, the cloud server can implement a read-your-own-writes, such that local writes performed by the user are visible by a select list of users.

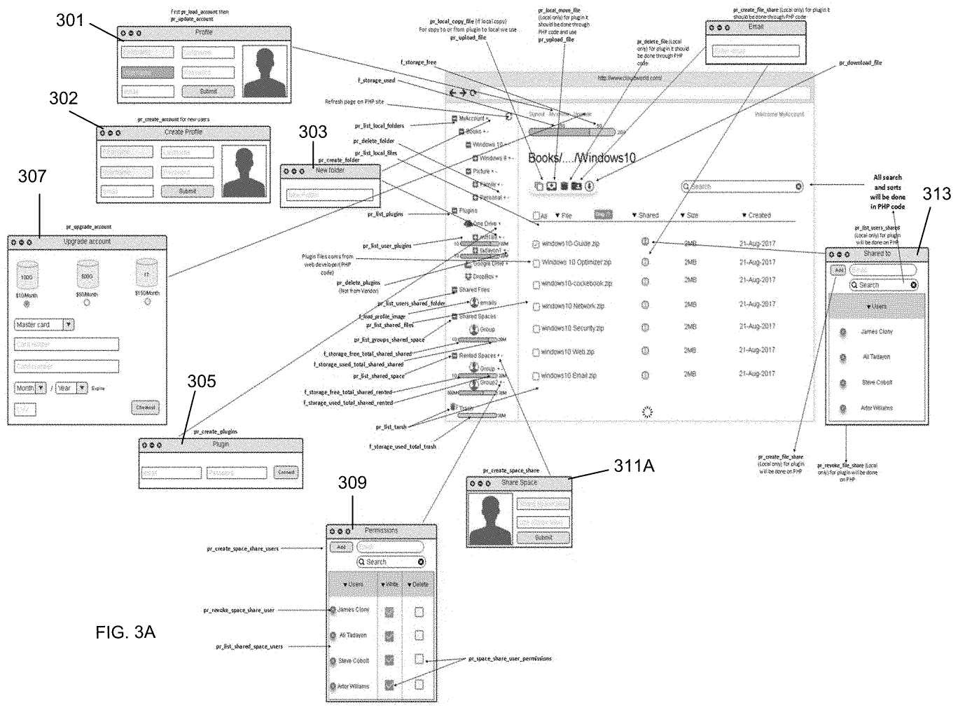

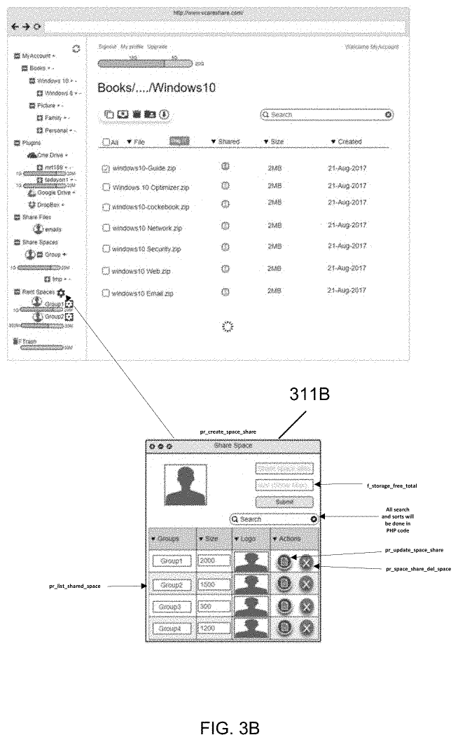

Referring to FIGS. 3A and 3B, there is disclosed an example of a more detailed diagram of the interface 200 of a cloud aggregator system of FIG. 2. At 301, there is shown a dialog for updating a user profile of an account on the cloud aggregator system. At 302, there is shown a dialog box for creating a user profile.

At 303, there is shown a dialog box for adding a new folder on the plugins tab. At 305, there is shown a plugin dialog box for adding a plugin to the plugin tab. At 307, there is shown a dialog box for upgrading a user account. At 309, there is shown a permission dialog box, to update privileges associated with the rented spaces. At 311A, there is shown a dialog box for creating a rented space. At 311B on FIG. 3B, there is shown a dialog box for setting the features (size, group, logo, actions) of a rented space. At 313, there is shown a dialog box for reviewing the list of users sharing a space.

A method of sharing a file and/or space on a cloud aggregator system aggregating a number of external cloud service provided herein. The method includes authenticating a user of the cloud aggregator system. The method also includes determining an amount of available space on the cloud aggregator system and/or on external cloud service providers communicating with the cloud aggregator system.

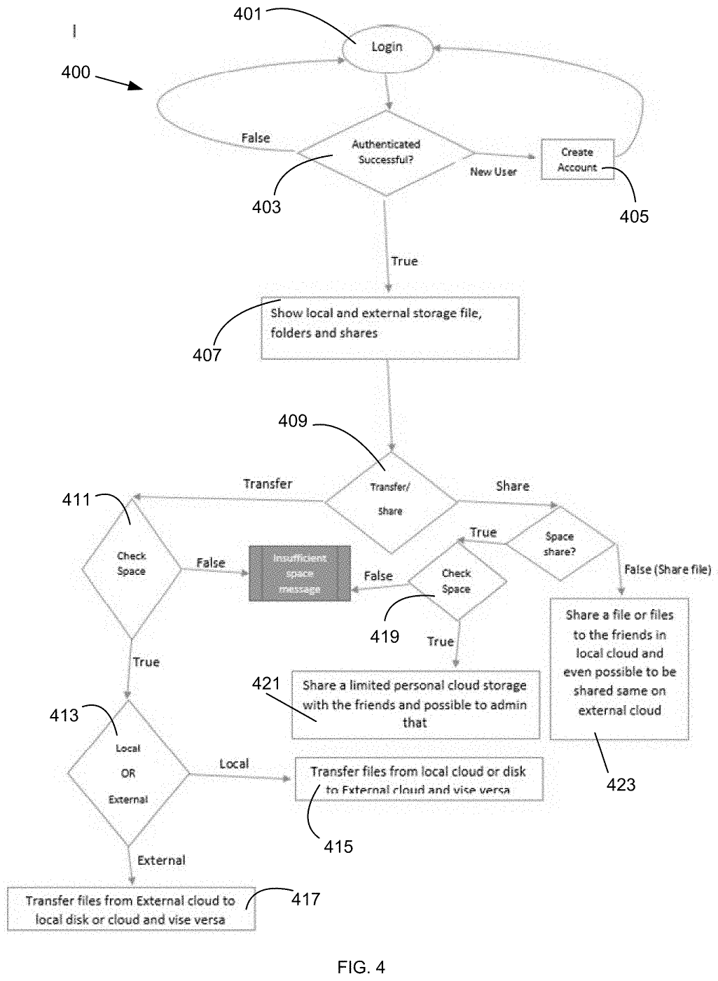

Referring to FIG. 4, there is shown a method 400 for using a cloud aggregator system. At 401 a user logs in into the system. At 403, the system authenticates the user. If the user is a new user, the user can create an account of the cloud aggregator system at 405. Once the user is logged into the system, the user can explore local and external storage files, folders and shares, as shown at 407.

At 409, a user can request to transfer a file or a space. If there is a transfer, the system will check at 411 whether there is enough space on the internal database. If there is enough space, the system can perform a local transfer or an external transfer at 413. At 415, in a local transfer, the system transfers files from local could or disk to an external cloud system (such as an external service provider). At 417, in an external transfer, the system transfers files from external cloud to local disk or cloud.

At 409, a user can also request to share a space or file. At 419, the system check the space share request to determine whether there is sufficient space resources. At 421, the system shares cloud storage with another user. In the event there is a file share request, at 423, the system share the file with another user.

In another embodiment, a method further includes determining whether a desired share is local and/or external. A local share is sharing, such that the file is to be saved on an internal database of the cloud aggregator system. This option advantageously allow the cloud aggregator system to have control over such file. For example, privileges can be defined for such file such that only a limited number of people can have access to the file or delete the file. An external share is sharing a file, such that the file is saved on a database of one the external cloud service providers. This option is attractive when the cloud aggregator system has a limited amount of storage space and more cloud storage space is required. Furthermore, the method includes sharing the file locally or externally. For example, a user can be allowed to manage privileges access to the file share and/or cloud storage.

A method of renting a space on a cloud aggregator system aggregating a number of external cloud service providers includes authenticating a user of the cloud aggregator system and determining an amount of available space on the cloud aggregator system and/or on an external cloud service provider. The method also includes determining whether a desired rent of a space is local or external. A local rent is renting a space located on a database of the cloud aggregator system. This option advantageously allow the cloud aggregator system to have control over the rented space, such that periodic copies of the space can be made internally. For example, privileges can be defined for the rented space. An external rent is renting a space located on a database of an external cloud service provider. This option is attractive when the cloud aggregator system has a limited amount of storage space and more cloud storage space is required. The method further includes renting the space locally or externally.

Privileges can be defined for the rented space. For example, the privileges can include Read, Write, Share, Manage and Delete privileges. For example, conditions can be defined for the rented space. For example, the condition can include: a renting space term; a required geographic location; a response time; a billing/pricing condition; an allocation of a specific amount of storage; an allocation on demand condition; and an encryption requirement.

For example, a user can perform one or more of the following actions on cloud-stored files: moving files and/or folders between providers, deleting files and/or folders, downloading files and/or folders to local internal database, and/or emailing a link to the files and/or folders to one or more recipients. For example, a user can also request that a file, directory, or directory of files be transformed (such as via a backend processing system) which allows the user and/or the aggregated file system storage provider system to request asynchronous processing of files on any combination of cloud storage providers. For example, the user can directly or indirectly initiate the processing. For example, once the processing is complete, the cloud aggregator system can notify the user via, for example, email, text message, MMS message, instant message, and/or digital transmission available.

For example, the system and/or user initiated operations can be serviced by a backend processing system. For example, those operations can include: converting one file into multiple files of a similar or different format; converting multiple files in into a single file of a similar or different format; performing operations on files that may include creation of one or multiple further tasks to be performed on the source, destination, or any other file regardless of location; converting the file to and from a video or compression format; copying, moving, deleting, archiving, backing up or in any other way changing a single file, a directory of files, every file in the directory, or any combination of the above using simple and/or compound filters to assess which files have received which operations performed thereon. All of these operations may be user initiated, or system initiated, or configured by the user to operate at a certain time and/or set of conditions.

For example, users of the cloud aggregator system can share, create and modify files amongst each other.

For example, once a user installs and/or uploads an application for accessing the cloud aggregator system, or accesses the cloud aggregator system through a web-based program, the user can be encouraged to configure the system to allow access to any combination of supported file storage providers. After initial setup, the user may use any combination of applications to access their cloud-stored digital content, from one single aggregated file system storage provider, instead of having to access each individual file storage providers separately.

For example, a file storage aggregation API can be configured to communicate with any number or combination of specified file storage providers. For example, the interface between the aggregated file storage provider and both the user's device and the cloud file storage providers can be established via a private or public network or through the Internet.

While the above description provides examples of one or more apparatus, methods, or systems, it will be appreciated that other apparatus, methods, or systems may be within the scope of the claims as interpreted by one of skill in the art.

1. A system for aggregating a plurality of cloud-based services and permitting a user to access and share files and storage space, the system comprising:
an internal database hosted on a computer server, the internal database comprising machine-readable computer storage media configured to store computer files and provide access to storage space, both the computer files and the storage space being associated with an account of a user;
a server configured to access the internal database;
an application configured to access the server, the application comprising an interface for the exchange of information between a user device and the server, wherein the server provides a plurality of computing services to the user, and wherein the server is configured to:
access and manipulate files and storage located on a user account of an external cloud service provider;
share files between users of the cloud aggregator system;
share space between the users of the cloud aggregator system; and
allow a user to rent space to another user of the cloud aggregator system.

2. The cloud aggregator system of claim 1, wherein the interface is a web-based interface.

3. The cloud aggregator system of claim 1, wherein the external user does not have an account with the cloud aggregator system.

4. The cloud aggregator system of any one of claims 1 to 3, wherein the server allows the user with an account on the cloud aggregator system to store files on the internal database.

5. The cloud aggregator system of any one of claim 1, wherein the server allows the user to define access privileges over the shared space.

6. The cloud aggregator system of any one of claim 1, wherein the server allows the user to define access privileges over the rented space.

7. The cloud aggregator system of claim 5, wherein the access privileges comprise at least one of read, write, share, manage and delete privileges over the rented space.

8. The cloud aggregator system of any one of claim 1, wherein the server allows the user to define at least one condition for the rented space.

9. The cloud aggregator system of any one of claim 1, wherein the at least one condition comprises: a renting space term; a required geographic location; a response time; a billing/pricing condition; an allocation of a specific amount of storage; an allocation on demand condition; and an encryption requirement.

10. A method of sharing a file and/or space on a cloud aggregator system aggregating a number of external cloud service providers, comprising:
authenticating a user of the cloud aggregator system;
determining an amount of available space on the cloud aggregator system and/or on at least one of the external cloud service providers;
determining whether a desired share is local and/or external,
wherein a local share is a share of a file that is to be saved on an internal database of the cloud aggregator system, and wherein an external share is a share of a file that is to be saved on a database of the external cloud service providers; and
sharing the file locally and/or externally.

11. The method of claim 6 further comprising allowing a recipient of the file share and/or cloud storage share to manage privileges access to the file share and/or cloud storage share.

12. A method of renting a space on a cloud aggregator system aggregating a number of external cloud service providers, comprising:
authenticating a user of the cloud aggregator system;
determining an amount of available space on the cloud aggregator system and/or on at least one of the external cloud service providers;
determining whether a desired rent is local,
wherein a local rent is a rent of a space located on an internal database of the cloud aggregator system; and
renting the space locally.

13. The method of claim 12 further comprising defining access privileges associated with the rented space.

14. The method of claim 12, wherein the access privileges comprise at least one of read, write, share, manage and delete privileges.

15. The method of any one of claim 12 further comprising defining at least one condition for the rented space.

16. The method of claim 15, wherein the at least one condition comprises: a renting space term; a required geographic location; a response time; a billing/pricing condition; an allocation of a specific amount of storage; an allocation on demand condition; and an encryption requirement.

17. The method of claim 10, further comprising allowing a user to define access privileges over a shared space.

18. The method of claim 12, further comprising allowing a user to define access privileges over the rented space.

19. The method of claim 18, wherein the access privileges comprise at least one of read, write, share, manage and delete privileges over the rented space.

20. The method of claim 12, further comprising allowing the user to define at least one condition for the rented space.

21. The method of claim 20, wherein the at least one condition comprises: a renting space term; a required geographic location; a response time; a billing/pricing condition; an allocation of a specific amount of storage; an allocation on demand condition; and an encryption requirement.
